(19) United States
(12) Patent Application Publication
(10) Pub. No.: US 2002/0077846 A1
(43) Pub. Date: Jun. 20, 2002

(54) Method and system for document or content off-loading to a document repository

(75) Inventors: Matthias Stefan Bierbrauer, Stuttgart (DE); Daniel Haenle, Stuttgart (DE)

Correspondence Address: Jeffrey S. LaBaw, International Business Machines, Intellectual Property Law, 11400 Burnett Road, Austin, TX, 78758, US

(73) Assignee: INTERNATIONAL BUSINESS MACHINES CORPORATION, ARMONK, NY

(21) Appl. No.: 10/015,226

(22) Filed: Dec. 17, 2001

(30) Foreign Application Priority Data
Dec. 15, 2000 (DE) 00127582.5

(51) Int. Cl. G06F 17/60

(52) U.S. Cl. 705/1

(57) ABSTRACT

Disclosed are a method and system for handling document or content off-loading from a document processing system to a large repository. The content of a document or any attachment attached to the document are detached and physically transferred to a remote repository server and replaced by a placeholder text. The text contains information, e.g., about who archived the document, the time/day of archiving, and the original attachment filename. In particular, the placeholder text itself is a URL link, for instance a Notes URL link hotspot richtext element. That is, when clicked, a browser is opened, displaying the URL associated with the URL link.

That solution is less resource consuming than the prior art approaches. It can advantageously be used in mail clients where mail documents, content or attachments are archived to a remote repository server and can be viewed directly without physically transferring them.

### BACKGROUND OF THE INVENTION

The invention relates to data processing environments with large document repositories and more specifically to a method and system for off-loading a document's content from a document processing system to a remote repository.

Known client mailing applications like Lotus™ Notes™ or Microsoft™ Outlook™ contain continuously growing document repositories, namely the incoming and outgoing notes or emails often including large attachments like text documents, graphics or even storage consuming digitized pictures. Therefore, e.g., a Lotus Notes application uses a Lotus Domino™ database from which a tool like IBM Content Manager CommonStore™ for Lotus Domino (CSLD) is used to move documents stored in that database to an archive physically located on a different device like a tape storage. CSLD thereupon allows to access documents that have previously been archived.

CSLD also allows to access documents that have been archived from any archive client application (e.g., scanning applications, CommonStore for SAP™, etc). When documents are retrieved from the archive to a Notes database, a Lotus Notes document is created.

In most scenarios, such documents are viewed only once with a Notes internal or external viewer, and then become obsolete. However, such temporary retrieval documents waste resources and have impact on the overall performance of the Notes application. Therefore, users have to delete these documents. But since the main interest of a user is to view an archived document, there is actually no need to retrieve a document to Lotus Notes.

### SUMMARY OF THE INVENTION

It is therefore an object of the present invention to provide a method and system for handling content off-loading from a document processing system to a large repository which is less resource consuming than the prior art approaches.

Another object is to provide such a method and system which allow to retrieve off-loaded content, minimally wasting resources.

It is yet another object to provide such a method and system which enables viewing of off-loaded content in a user-friendly way.

The above objects are achieved by the features of the independent claims. Advantageous embodiments are subject matter of the subclaims.

The idea underlying the invention is to provide a URL link to off-loaded content and to enable to display the content in a viewing application. In particular, it is proposed to detach the content from a document, to transfer it to a remote repository, and to replace it by a placeholder text implemented as a URL link. The text can contain information, e.g., about who off-loaded or archived the document/content, the time/day of off-loading, and the original attachment filename, in order to identify the off-loaded content. The URL link, for instance, is a Notes URL link hotspot richtext element. That is, when clicked, a browser is opened, displaying the content associated with the URL link.

That solution is less resource consuming than the prior art approaches, particularly regarding storage capacity and network traffic. It can advantageously be used, e.g., in mail clients where mail documents, content or attachments are archived to a remote repository server, and can be viewed directly without physically transferring them to the mail client.

It is understood hereby that the above mentioned remote repository server can also be a local hard disk.

The invention can be applied to every known mail client program or system and anables worldwide viewing of a document. Preferably, archived documents can be viewed within the mail client via the URL links, e.g., by using a common web browser either as a plug-in to the mail client or a separate web browser that is automatically started when the URL is clicked.

Preferably, an underlying mail server, e.g. Domino server, is connected to a web dispatcher component, which is basically a stripped-down web server with special archive-related functionality. The web dispatcher provides web access to an archived content. Hereby, requests to be processed by the web dispatcher are sent as HTTP requests with a defined parameter set.

In another embodiment, when a document is off-loaded, it is assigned a unique identifier (ID). The ID becomes part of the URL and can be encrypted for security reasons.

In another embodiment, the document's type or the document's content type is stored with a document when the document is off-loaded. Hereby, the aforementioned web dispatcher can maintain a mapping table mapping content types to MIME types. This allows the browser to interpret each file correctly.

In yet another embodiment, the aforementioned browser viewing is performed from within a search hitlist, i.e. when a search over the repository returns a hitlist document. For every hit in the hitlist, a button and an URL link hotspot are displayed. When the button is pushed, the corresponding content is retrieved. When the URL link is pushed, the content is viewed in a plug-in or separate web browser. This allows to quickly view content to find out whether it is the desired one. Then, if necessary, it can be retrieved back to the mail client. It is noteworthy that, instead of using a web browser for viewing an off-loaded content, every kind of HTTP client tool can be used.

### BRIEF DESCRIPTION OF THE DRAWINGS

In the following, the present invention is described in more detail by way of embodiments from which further features and advantages of the invention become evident whereby

FIG. 1 is an overview block diagram showing a document before and after content off-load according to the invention;

FIG. 2 is a flow diagram illustrating basic components and data flow of a preferred embodiment of the invention;

FIG. 3A is a diagram showing various steps of a content off-load procedure according to the invention;

FIG. 3B is another diagram showing various steps of content retrieval according to the invention; and

FIG. 3C is another diagram another embodiment of content retrieval via a search over a repository.

### DETAILED DESCRIPTION OF THE DRAWINGS

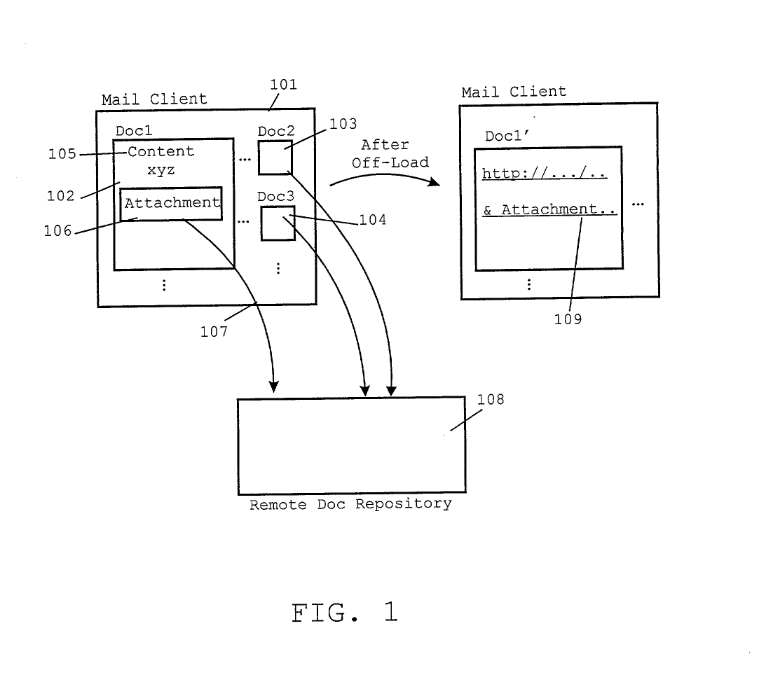

FIG. 1 illustrates the basic concept of the invention by showing a document before and after content off-load according to the invention. A mail client 101 that has stored a number of email documents 102-104 (doc1, . . . ), each of them containing content 105 (XYZ), and possibly one or more attachments 106.

During an off-loading procedure, the content 105 and the possible attachments 106 are detached from the document 102 and transferred 107 to a remote repository server 108. In the original document 102, after the off-loading 107, the content 105 is replaced by a placeholder text 109, i.e. a Lotus Notes URL link hotspot richtext element in the present example. Possible attachments 106 are replaced by a corresponding URL.

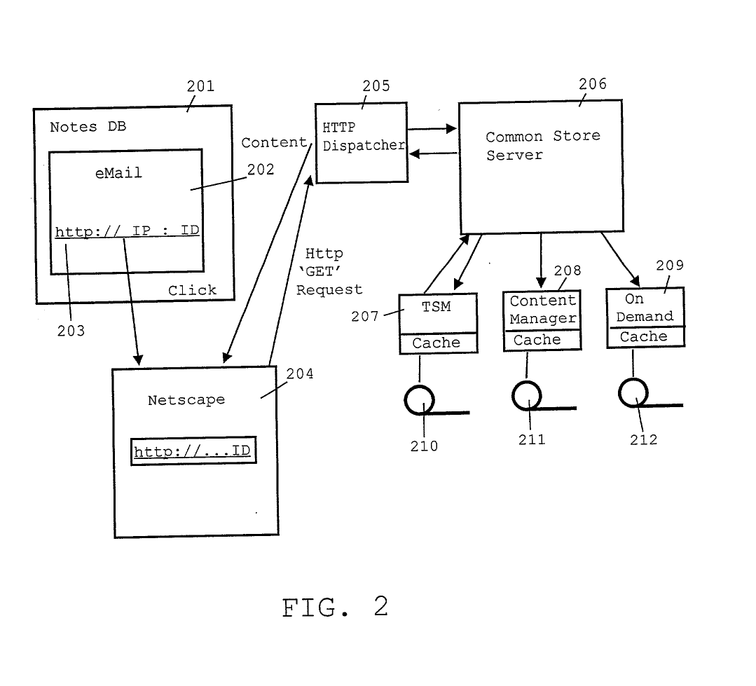

The block diagram depicted in FIG. 2 shows a Lotus Notes environment as an example of a document processing system. The system is shown in a state after an already performed off-loading procedure. It comprises a Notes database 201 (Notes DB) for which an exemplary eMail document 202, where the document content were replaced by a URL link hotspot richtext element 203 as discussed beforehand. The URL text contains information about who archived the document, time/day of archiving, and the original attachment filename. For example

<<<Attachment ‘CSLDClient.sys’ has been archived by user ‘Daniel Haenle/Germany/IBM’ on ‘09/20/2000 11:32:18 AM’. >>>

When the URL link 203 is clicked, a browser 204 (in the present example a Netscape™ web browser) is started, connecting to the given URL 203. When a document is off-loaded by CSLD 206, it is assigned a unique identifier (ID). The ID is encrypted for security reasons and becomes part of the URL 203. An HTTP “GET” request together with the ID is sent from the web browser to an HTTP dispatcher 205 which is a stripped-down HTTP server. The goal of the HTTP dispatcher 205 is to provide web access to archive content. Requests to be processed by the HTTP dispatcher 205 are sent as HTTP requests with a defined parameter set.

The CSLD HTTP dispatcher 205 extracts the encrypted ID from the URL 203, decrypts it, retrieves the content from the repository, and sends it to the browser, where it is displayed. Of course, for some document types a special browser plugin is required.

The HTTP dispatcher 205 forwards the request to IBM Content Manager CommonStore™ for Lotus Domino 206 (CSLD) and requests the content having the sent ID, referred to in the URL 203. The CSLD 206, in particular, provides an interface to one or more document repositories 207-209. The repository or repositories, in the present embodiment, is (are) comprised of Tivoli™ Storage Manager™ 207 (TSM), Content Manager™ 208 and Content Manager™ OnDemand™ 209. Each of these three components 207-209 can be connected to one or more tape storage devices 210-212. TSM 207 retrieves the content requested by the HTTP “GET” request and returns it to CSLD 206. Finally, the retrieved content can be viewed using the Netscape browser 204.

A complete URL 203 computed by CSLD 206 during off-loading consists of the IP address or host name running the HTTP dispatcher 205, the HTTP dispatcher port, the internal command sGet and an encrypted document ID. An example is

http://popken.boeblingen.de.ibm.com:8085/?sGet&DI1eTH1W Xw1jABdcAIF5XBJqYn8HCHRhIX9nC2VmYXd%2Ba1J XAEJ5XBJXTkRRa0FuCEBDUUBdEgAAeQRtMjA4LzM VMDBNMTgM

When a document is off-loaded by CSLD 206, the document's content type is stored with the document. The HTTP dispatcher 205 maintains a (not shown) table mapping content types to MIME types. This allows the web browser 204 to interpret the file correctly.

It is noted that the browser viewing feature has nothing to do with Notes except that the URL link 203 is kept in a mail document 202. Therefore, no temporary Notes retrieval documents are created.

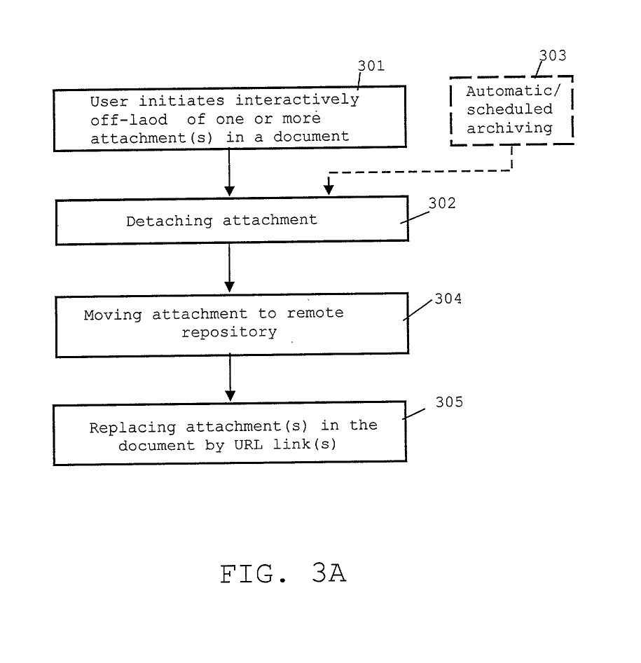

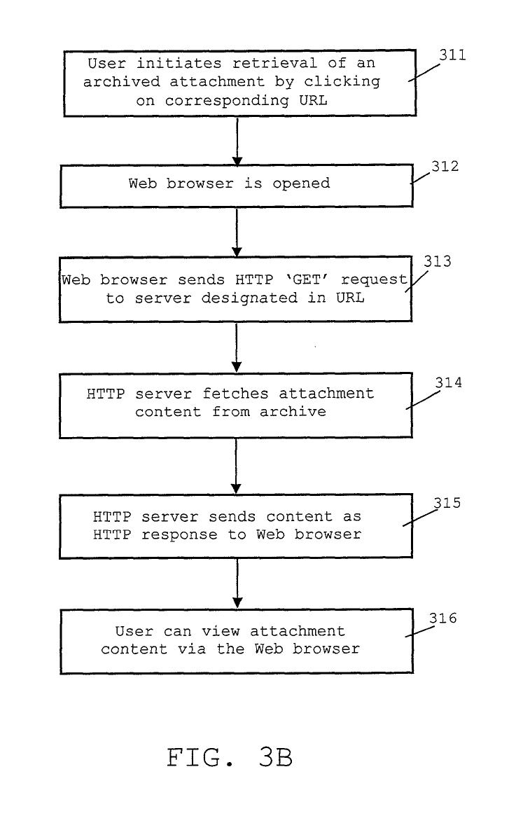

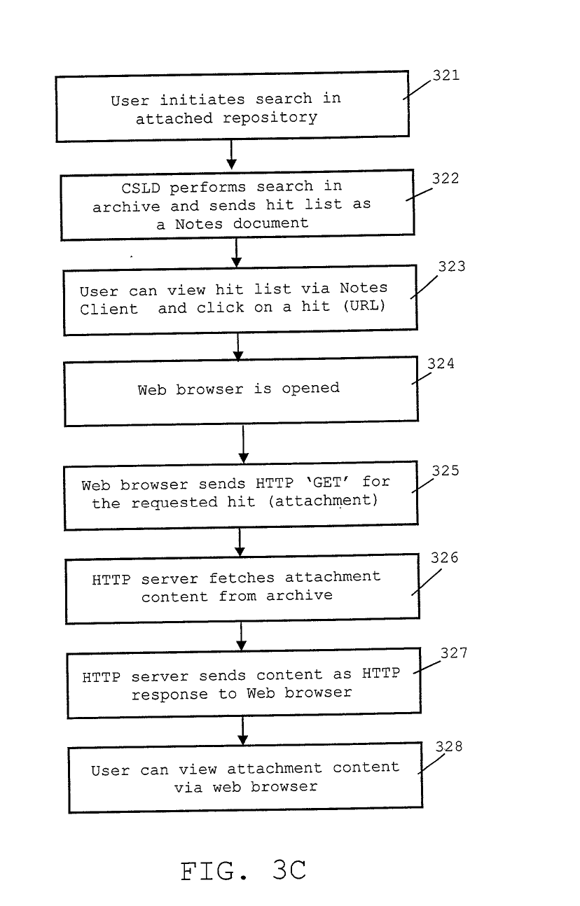

FIG. 3A is a diagram showing various steps of a content off-load procedure according to the invention illustrated for attachment archiving. A user starts 301 the off-load procedure by, e.g., pushing an ‘archive’ button in the Notes client. Alternatively, the procedure can be triggered automatically 303. The attachment is detached 302 by CSLD and moved 304 to a repository. Afterwards, CSLD replaces 305 the attachment(s) by a URL link.

FIG. 3B shows the scenario for a single content retrieval in case of an off-loaded attachment. The user initiates 311 retrieval by clicking the URL link which opens 312 a web browser. The web browser sends 313 an HTTP “GET” request to the server designated in the URL. The HTTP server retrieves 314 the attachment from the repository via CSLD. The content is sent back 315 as an HTTP response to the web browser. Finally, the browser displays 316 the attachment.

FIG. 3C shows the scenario for retrieving an attachment via a search over the repository. A user initiates 321 a search in the repository. CSLD performs 322 that search and returns the result as a Notes hitlist document. From that hitlist, the user can click 323 on a URL representing a certain hit. This opens 324 a web browser. The web browser sends 325 an HTTP “GET” request to the server specified in the URL. The HTTP server retrieves 326 the attachment from the repository via CSLD. The content is sent back 327 as an HTTP response to the web browser. Finally, the browser displays 328 the attachment.

It should be noted that the above described browser viewing shall not be confused with the browser viewing feature in a Domino web client. With a Notes web client, Notes databases are accessed from within a browser. With CSLD browser viewing, content in an archive is viewed in a browser without retrieving the content to Lotus Notes. Browser viewing also works with the Notes web client. That is, it makes no difference whether a document URL link is clicked in a document being viewed in the Notes client or in a document being viewed in a Domino web client. In both cases, no Lotus Notes document is created.

CSLD browser viewing also allows users to forward an URL link to other users, even to those who have no Notes client installed. All these users will be able to view the document in a browser. A further application of CSLD browser viewing is viewing of archived documents for which no Notes viewer exists, but which are supported by a browser (native or via plugin).

1. A method for handling content off-loading from a document processing system to a document repository, comprising the steps of:
detaching content from the document;
transferring the detached content to the document repository; and
replacing the content by a URL link placeholder.

2. The method according to claim 1, wherein the content is the whole document or at least part of the document.

3. The method according to claim 1, wherein the URL link placeholder contains additional information identifying the off-loaded content, in particular information about the user who off-loaded the document/content and/or the time/day of off-loading and/or an original document/content designation.

4. The method according to claim 1, wherein the URL link placeholder is a Notes URL link hotspot richtext element.

5. The method according to claim 1, further comprising the step of viewing the detached content at the client via the URL link.

6. The method according to claim 5, wherein a web browser is used for viewing the detached content.

7. The method according to claim 1, further comprising the step of providing a web dispatcher component being a stripped-down web server that provides web access to off-loaded content.

8. The method according to claim 7, wherein access requests to be processed by the web dispatcher are sent as HTTP requests with a defined parameter set.

9. The method according to claim 1, further comprising the step of assigning a unique identifier for off-loaded content.

10. The method according to claim 9, wherein the unique identifier is part of the URL and/or is encrypted.

11. The method according to claim 1, wherein a document's content type is stored with the content when it is off-loaded.

12. The method according to claim 11 further comprising the step of maintaining a table mapping content types to MIME types.

13. The method according to claim 1, comprising the steps of:
performing a search over a repository containing off-loaded content;
returning a hitlist document; and
for every hit in the hitlist document, displaying a button to retrieve the content associated with a hit and/or a URL link to view the content associated with a hit.

14. A system for handling content off-loading from a document processing system to a document repository, comprising:
means for detaching content from the document;
means for transferring the detached content to the document repository;
means for replacing the content by a URL link placeholder.

15. The system according to claim 14, where the client comprises a web browser or HTTP client tool for viewing the detached content.

16. The system according to claim 14, further comprising a web dispatcher component being a stripped-down web server that provides web access to off-loaded content.

17. The system according to claim 14, further comprising means for assigning a unique identifier to off-loaded content.

18. The system according to claim 14, further comprising means for encrypting the unique identifier as part of the URL.

19. The system according to claim 16, wherein the web dispatcher maintains a table mapping content types to MIME types.

20. A computer program product stored in a computer usable medium, for off-loading from a document processing system to a document repository comprising:
means for detaching content from the document;
means for transferring the detached content to the document repository; and
means for replacing the content by a URL link placeholder.

21. The product according to claim 20, wherein the content is the whole document or at least part of the document.

22. The product according to claim 20, wherein the URL link placeholder contains additional information identifying the off-loaded content, in particular information about the user who off-loaded the document/content and/or the time/day of off-loading and/or an original document/content designation.

23. The product according to claim 20, wherein the URL link placeholder is a Notes URL link hotspot richtext element.

24. The product according to claim 20, further comprising means for viewing the detached content at the client via the URL link.

25. The product according to claim 24, wherein a web browser is used for viewing the detached content.

26. The product according to claim 20, further comprising means for providing a web dispatcher component being a stripped-down web server that provides web access to off-loaded content.

27. The product according to claim 26, wherein access requests to be processed by the web dispatcher are sent as HTTP requests with a defined parameter set.

28. The product according to claim 20, further comprising means for assigning a unique identifier for off-loaded content.

29. The product according to claim 28, wherein theunique identifier is part of the URL and/or is encrypted.

30. The product according to claim 20, wherein a document's content type is stored with the content when it is off-loaded.

31. The product according to claim 30 further comprising means for maintaining a table mapping content types to MIME types.

32. The product according to claim 20, further comprising:
means for performing a search over a repository containing off-loaded content;
means for returning a hitlist document; and
Means responsive to every hit in the hitlist document for displaying a button to retrieve the content associated with a hit and/or a URL link to view the content associated with a hit.
